(19) United States
(12) Patent Application Publication
(10) Pub. No.: US 2007/0146716 A1
(43) Pub. Date: Jun. 28, 2007

(54) Device and method for non-contact sensing of low-concetration and trace substances

(75) Inventors: Alexander E. Dudelzak, Ottawa (CA); Guerman A. Pasmanik, North York (CA); Alexander Shilov, Vaughan (CA); Evgueni Shklovskiy, North York (CA)

Correspondence Address: WELSH & KATZ, LTD, 120 S RIVERSIDE PLAZA, 22ND FLOOR, CHICAGO, IL, 60606, US

(73) Assignee: Laser Diagnostic Instruments International, Inc., Ottawa. Ontario (CA)

(21) Appl. No.: 10/578,794

(22) PCT Filed: Jan. 14, 2005
(86) PCT No.: PCT/CA05/00044

§ 371 Date: May 5, 2006

Related U.S. Application Data
(60) Provisional application No. 60/536,228, filed on Jan. 14, 2004.

(30) Foreign Application Priority Data
May 28, 2004 (CA) 3468924

(51) Int. Cl. G01N 21/00; G01J 4/00

(52) U.S. Cl. 356/437; 356/364

(57) ABSTRACT

A device for non contact detection of low concentration substances outside a laboratory environment is disclosed. A probing laser emission is split into two linear orthogonally polarized emission components and one component is delayed in time relative to the other. Both components are directed to a focal region that is proximate to a target medium thought to contain the substance to be detected. Between the arrival of the first and second emission components, an excitation light pulse at a wavelength corresponding to an absorption line in the spectrum of the substance is directed to the focal region. If vapours of the substance are present, they will be heated by the excitation pulse and will change the index of refraction of the focal region before the second emission component passes through it, thus altering the phase of the back-scattered emission returns. The device delays the first returned component by an equal delay and coherently couples the returned emission components. The amplitudes of the orthogonally polarized returned emission components are compared. If the probing laser is pulsed, the ratio of the polarized pulse components is observed to indicate the presence of the substance. Optionally, reference pulses for which no excitation pulse is generated may be introduced to provide a reference signal to rule out effects due to the intrinsic polarization caused by passage of the emission through optical components. If the probing laser is a continuous wave laser, the presence of transients timely correlated with excitation pulses in the detected continuous wave signal will indicate the presence of the substance.

### FIELD OF THE INVENTION

The present invention relates to remote sensing of low-concentration and trace substances. In particular, the present invention relates to the remote sensing of low-concentration and trace substances such as explosives.

### BACKGROUND OF THE INVENTION

Traditionally, the identification of substances has involved the identification and measurement of the substances' characteristic spectra, such as through fluorescent and spectroscopic analysis. More recently various photothermal spectroscopic approaches, such as photoacoustic spectroscopy and photo-thermal deflection spectroscopy have been proposed. Such approaches rely on the so-called “thermal lens” effect, in which a weakly absorbing substance is excited by an energy source, such as a flux of photons having a wavelength with which the substance is resonant, producing a change in the refractive index along the energy path, due to the heating of the substance's vapours by the energy source. The thermal lens thus created has been suggested for measuring absorption and for application in spectrophotometry and spectroscopy.

The thermal lens effect was first described in Gordon, J. P. et al. “Long—Transient Effects in Lasers with Inserted Liquid Samples”, Journal of Applied Physics 36, 3 (1965). Buildup and decay transients of laser oscillation were observed when cells containing liquids were placed inside the resonator of a He—Ne laser operating at 633 nm. Similar but less pronounced effects were also observed with two solids. Transverse motion of the cell by about one beam width caused new transients that were similar to the initial ones. The authors believed that the effects were caused by absorption of the He—Ne laser emission in the tested materials, producing a local heating in the vicinity of the beam, and a lens effect due to the transverse gradient of the refractive index. The authors found that absorption of between 10⁻³ and 10⁻⁴ cm⁻¹ was sufficient to produce the effect.

Subsequent to this publication, it was determined that the thermal lens effect provided a mechanism to measure the weak absorption of light in transparent materials.

In Solmini, Domenico, “Accuracy and Sensitivity of the Thermal Lens Method for Measuring Absoprtion”, Applied Optics, Vol. 5, No. 12, 1931 (1966), the accuracy and sensitivity of the thermal lens effect for measuring absorption was studied using a geometry in which two lenses were inserted into an optical resonator. The author concluded that the absorbency of transparent materials could not be measured in a simple manner by photometric methods, but confirmed that the thermal lens effect provided a measurement for measuring absorbencies as low as 10⁻⁵ cm⁻¹. He concluded that the sensitivity of the effect was related to the configuration of the resonator, nearly confocal resonators being the most sensitive. However, the author pointed out that because near confocal resonators manifest effects inimical to precise measurement, cavities that are far from the confocal configuration may be more practical.

In Jackson, W. B. et al. “Photothermal deflection spectroscopy and detection”, Applied Optics, Vol. 20, No. 8 1333 (1981), the theoretical foundation of photothermal deflection spectroscopy (PDF) was developed. Two main PDF configurations were considered, namely collinear photothermal deflection, where the gradient of the index of refraction was both created and probed within the sample, and transverse photothermal deflection where the probing of the gradient of the index of refraction was accomplished in the thin layer adjacent to the sample. The authors found that the latter approach is most suited for opaque samples and for materials with poor optical quality. Earlier experiments by other authors were compared and the theoretical predictions were experimentally verified. In summarizing some photothermally-based spectroscopies, the authors provided sensitivities of different experimental set-ups. The sensitivity (in units of (α1)ₘᵢₙ×pump power (Watts)) ranged from 10⁻⁴ for microphone photoacoustic spectroscopy to 10⁻⁸ for collinear PDF. Special features were noted as being pertinent to particular set ups.

In U.S. Pat. No. 4,544,274 issued to Cremers et al., there is disclosed a variant of the thermal lens method, in which a cell containing the sample is inserted into a laser resonator for measurement of weak optical absorptions. In the Cremers et al. method, the output coupler of the resonator is deliberately tilted relative to the CW laser beam circulating in the resonator to produce a pulsed laser output, whose pulse width could be related to the sample absorptivity by a simple algorithm or calibration curve, thus demonstrating a measured absorption of 10⁻⁵ cm⁻¹.

In Kawasaki et al., “Thermal Lens Spectrophotometry Using a Tunable Infrared Laser Generated by a Stimulated Raman Effect”, Anal. Chem. 59, 523 (1987), thermal lens spectrophotometry utilizing a tunable infrared laser source was applied to record the spectrum of ammonia in gaseous phase to a spectral resolution of 0.1 cm⁻¹. The detection limit was 6% for the line at 1025.69 nm when available 0.13 mJ, 10 ns pulses at 1015 nm-1040 nm were focused into a flow cell. The authors felt that once more powerful infrared lasers were created, the sensitivity of the method could be improved by several orders of magnitude.

In U.S. Pat. No. 4,310,762 issued to Harris et al, there is disclosed a technique based on laser induced thermolens. In that technique a laser beam travels through two cells, a reference cell and a sample cell. The cells are located at points in the beam path such that any modification in the beam caused by a change in the index of refraction of the medium in the reference cell is cancelled by the use of the same medium in the sample cell. Therefore, any detectable modification in the beam, such as beam expansion or change of its divergence as it escapes the sample cell, must be caused by the change in the thermal lens in the material under identification.

In the foregoing exemplary references, as well as others, the thermo-optical effect was exploited for determining weak light absorption in different transparent media for finding trace substances and for other spectroscopic purposes. However, each disclosed high sensitivity methods and apparatus that were suitable for the laboratory environment only.

There have been developed a number of optical techniques, based mainly on lidars, which are capable of the remote detection of trace substances in air, on water and on ground surface. None of these methods use the thermo-optical effect. However, if such a method could be developed, it would provide an effective tool for the remote detection of ultra-low concentration substances, such as vapour/gas leaks, side products of the hazardous waste industry as well as trace explosive materials, with high spatial resolution.

In Bubis, E. L., et al., “Research of low-absorptive media for SBS in near infrared spectral band”, Optica e Spektroskopiya, Vol. 65, No. 6, 1281 (1988), the thermal lens method was combined with the dark-field method to determine weak absorption of liquids used in phase conjugate mirrors. This approach has demonstrated the possibility of using the thermo-optical effect for the remote detection of low concentration admixture in different transparent media. The authors focused 0.2 ms pulses of between 0.1-5 J of a neobdynium laser having a beam waist of about 0.2 mm into a cell with liquid. A collimated probing beam of a He—Ne laser traversed through the waist along the axis of the pumping beam and was blocked by a copper foil 1 mm in diameter. A portion of the probing beam was scattered due to phase distortions caused by heat deposition in the focal region. The scattered component of the probing beam was registered by a photodetector. It was shown that the so-called critical energy, which is a feature of the tested liquid, particularly its absorbance, determined the weakest distortions detectable. In fact, it was possible to detect heat-induced distortion at 1/100 of the critical energy. With this method the authors measured absorbance as low as 10⁻⁶ cm⁻¹.

In Andreyev, N. F., et al., “Locked Phase Conjugation for Two Beam Coupling of Pulse Repetition Rate Solid-State Lasers”, IEEE J. of Quant. Electr., Vol. 27, No. 9, 1024 (1991), the authors taught a method of coherent beam coupling.

### SUMMARY OF THE INVENTION

It is therefore an object of the present invention to detect low concentration and trace substances in an industrial environment.

It is a further object of the present invention to detect trace substances in air.

It is another object of the invention to detect trace substances in a thin layer near targets.

It is yet another object to detect trace substances with high spatial resolution.

The present invention extends the thermooptically-based method of detecting low concentration substances beyond a laboratory environment. It makes use of the thermal lens effect in conjunction with a method of coherent beam coupling to provide, in an industrial environment, a method and apparatus for detecting low concentration substances in air. The inventive method and apparatus may detect such substances, whether in the form of a gas, vapour or a cloud of dust particles. Typical applications of the inventive method and apparatus include the detection of vapour or gas leaks, side products of hazardous industries and trace explosive materials. Furthermore, the thermal lens effect may now applied to the remote sensing of trace substances with high spatial resolution.

This is achieved by focusing an excitation energy pulse having a wavelength for which the substance or substances to be detected is resonant, at the targeted area to provide a noticeable absorption over a short distance corresponding to the focal waist. A sensing probing pulse will be modified by the change in the refractive index in the focal area if even a low concentration of the substance is present to resonantly absorb the heating pulse. The modification is detected by comparison of the ratios of the orthogonal linear polarization components of the modified probing pulse and of a reference pulse, transmitted through the same focal region, but unperturbed by the excitation pulse, recreated through coherent beam coupling.

Alternatively, a CW stream of probing photons may be used. In this case, detection of the modification to the probing stream is shown by transients in the amplitude of the returned stream that correspond temporally to the introduction of these excitation pulses.

The inventive method takes advantage of a long focal distance objective (typically in the range of tens of meters) and high spatial resolution due to a narrow beam waist (typically in the range of hundreds of microns).

According to a broad aspect of the invention, there is disclosed an apparatus for non-contact detection of a substance in a target region, comprising; a laser source for generation of a probing light emission; an optical subsystem adapted to split a light emission into first and second emission components and to introduce a first delay to the second emission component relative to the corresponding first emission component; a lens subsystem adapted to accept all of the components in sequence and direct them to a focal region proximate to the target region along an optical axis; an excitation source adapted to direct energy at a wavelength corresponding to an absorption line in the spectrum of the substance, through the lens subsystem to the focal region, at a time between the first and second components so as to change the refractive index in the focal region if the substance is present in the target region before the passage of the second component through the focal region; an emission coupler adapted to: recover back-scattered returns of the emission components, introduce a second delay to the first returned emission component relative to the second returned emission component in an amount equal to the first delay, and coherently couple the emission components into a returned light emission; and a detection subsystem adapted to measure components of the returned emission to determine if there has been a change in the phase of the second returned emission component as a result of the presence of the substance in the target region.

According to a second broad aspect of the invention, there is disclosed a method for non-contact detection of a substance at a target region, comprising the steps of, radiating a probing light emission; splitting the emission into a first and second emission component; delaying in time the second emission component relative to the first emission component; directing all of the emission components in sequence to a focal region proximate to the target region; directing energy at a wavelength corresponding to an absorption line in the spectrum of the substance to the focal region at a time between the first and second emission components so as to change the refractive index in the focal region if the substance is present in the target region; recovering back-scattered returns of the emission components; delaying in time the first returned emission component relative to the second returned emission component by a value equal to the initial delay; coherent coupling the emission components into a returned emission; measuring components of the returned emission to determine if there has been a change in the phase of the second returned emission component as a result of the presence of the substance in the target region.

### BRIEF DESCRIPTION OF DRAWINGS

FIG. 1 is an optical diagram of an apparatus according to a first embodiment of the present invention;

FIG. 2 is a timing diagram showing an exemplary sequence of pulses that can be generated by the apparatus of FIG. 1;

FIG. 3 is a schematic representation of the focusing, by the objective of FIG. 1, of light beams into a target region; and

FIG. 4 is a timing diagram showing the temporal relationship between the pumping pulse and the responses received at the photodiodes of FIG. 1, according to a second, continuous wave (CW) embodiment of the present invention.

### DETAILED DESCRIPTION OF THE INVENTION

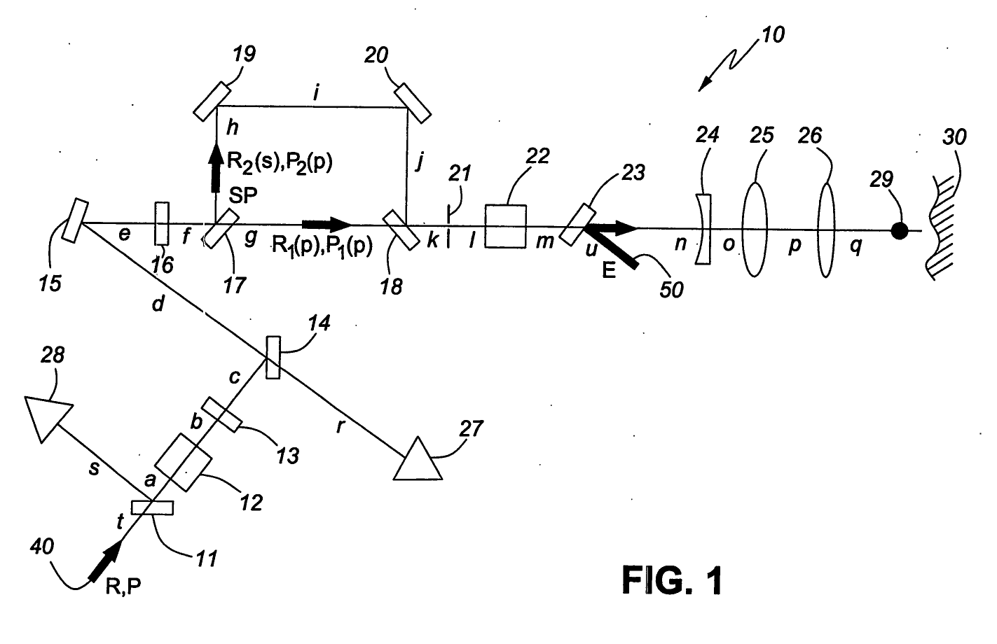

Referring now to FIG. 1, there is shown a simplified schematic diagram of a possible optical apparatus in accordance with a first embodiment of the present invention shown generally at 10 for remote detection of low concentration gas admixture in air in a target region (not shown) proximate to a focal region 29.

The apparatus 10 comprises a plurality of optical components, including a plurality of polarizers 11, 14, 17, 18, mirrors 15, 19, 20, 23, half wave plates 13, 16, Faraday rotators 12, 22, photodiodes 27, 28, lenses 24, 25, 26 and an aperture 21.

The apparatus 10 accepts laser light emissions as inputs 40 and 50. In this first embodiment, such laser emission 40, 50 are in pulsed form. Pulses 40 input along optical path t are incident on a polarizer 11, while pulses 50 input along optical path u are incident on a dichroic mirror 23. For ease of explanation, the direction along which photons proceed from path t through apparatus 10 until they pass through the focal region 29 along path q is denoted the forward direction, while the opposite direction is denoted the reverse direction.

Polarizer 11 accepts input photons 40 along optical path t and is optically connected to a Faraday rotator 12 by optical path a and to a photodiode 28 by optical path s. Polarizer 11 transmits p-polarized components of photons in both the forward and reverse directions, and reflects s-polarized components. Thus, in the forward direction, p-polarized components incident upon it along path t are transmitted through it along path a and impinge upon Faraday rotator 12, while s-polarized components are effectively reflected off. In the reverse direction, p-polarized components incident upon it along path a are transmitted through it along path t, while s-polarized components incident on it are reflected by it along path s to impinge upon photodiode 28. As will be discussed below, the optical configuration of the apparatus 10 ensures that there will be effectively no s-polarized components incident upon polarizer 11 along path a.

Photodiode 28 captures optical pulses reflected from polarizer 11 in the reverse direction, along path s and converts them into electrical pulses in proportion to the density of photons incident upon it. The electrical amplitude response of photodiode 28 is measured (not shown) for processing as discussed below.

Faraday rotator 12 is optically connected to polarizer 11 by optical path a and to a half wave plate 13 by optical path b. The Faraday rotator 12 is an irreversible optical element that rotates the polarization of the photons incident upon it by a certain angle, in this embodiment, +45°. Thus, photons travelling in the forward direction along path a from polarizer 11 to Faraday rotator 12, exit from it along path b with their linear polarization rotated by +45°, to impinge upon half wave plate 13. Photons travelling in the reverse direction along path b from half wave plate 13 to Faraday rotator 12, exit from it along path a with their linear polarization rotated by +45°, to impinge upon polarizer 11.

Half wave plate 13 is optically connected to Faraday rotator 12 by optical path b and to a polarizer 14 by optical path c. Half wave plate 13 is a reversible optical element that rotates the linear polarization of the photons incident upon it by +45°. Thus, photons travelling in the forward direction along path b from Faraday rotator 12 to half wave plate 13, exit from it along path c with their linear polarization rotated by an additional +45°, to impinge upon polarizer 14. Thus, in the forward direction, Faraday rotator 12 and half wave plate 13 act so as to change the linear polarization of photons incident upon Faraday rotator 12 along path a in the forward direction by +90°, that is to change p-polarized components to s-polarized components. However, photons travelling in the reverse direction along path c from polarizer 14 to half wave plate 13, exit from it along path b with their linear polarization rotated by −45°, to impinge upon Faraday rotator 12, so that the combined effect on the linear polarization of photons travelling in the reverse direction, of the half wave plate 13 and the Faraday rotator 12, is zero rotation angle.

Polarizer 14 is optically connected to half wave plate 13 by optical path c, to a photodiode 27 by optical path r and to a mirror 15 by optical path d. Polarizer 14 transmits p-polarized components of photons in both the forward and reverse directions, and reflects s-polarized components. Thus, in the forward direction, p-polarized components incident upon it along path c are transmitted through it and are effectively discarded, while s-polarized components are reflected by it along path d to impinge upon mirror 15. As will be discussed below, the optical configuration of the apparatus 10 ensures that there will be effectively no p-polarized components incident upon polarizer 14 along path c in the forward direction. In the reverse direction, p-polarized components incident upon it along path d are transmitted through it along path r to impinge upon photodiode 27, while s-polarized components incident on it along path d are reflected by it along path c to impinge upon half wave plate 13.

Photodiode 27 captures optical pulses reflected from polarizer 14 in the reverse direction along path r and converts them into electrical pulses in proportion to the density of photons incident upon it. The electrical amplitude response of photodiode 27 is measured (not shown) for processing as discussed below.

Mirror 15 is optically connected to polarizer 14 by optical path d and to a half wave plate 16 by optical path e. Mirror 15 reflects photons incident upon it from optical path d to optical path e and vice versa. Thus, photons incident upon it in the forward direction along path d are reflected along path e to half wave plate 16, while photons incident upon it in the reverse direction along path e are reflected along path d to polarizer 14.

Half wave plate 16 is optically connected to mirror 15 by optical path e and to a polarizer 17 by optical path f Half wave plate 16 is a reversible optical element that rotates the linear polarization of the photons incident upon it by +45°. Thus, photons travelling in the forward direction along path e from mirror 15 to half wave plate 16, exit from it along path f with their linear polarization rotated by +45°, to impinge upon polarizer 17. However, photons travelling in the reverse direction along path f from polarizer 17 to half wave plate 16, exit from it along path e with their linear polarization rotated by −45°, to impinge upon mirror 15.

Polarizer 17 is optically connected to half wave plate 16 by optical path f, to a polarizer 18 by optical path g and to a mirror 19 by optical path h. Polarizer 17 transmits p-polarized components of photons in both the forward and reverse directions, and reflects s-polarized components. Thus, in the forward direction, p-polarized components incident upon polarizer 17 along path f are transmitted through it along path g to impinge upon polarizer 18, while s-polarized components are reflected by it along path h to impinge upon mirror 19. In the reverse direction, p-polarized components incident upon it along path g are transmitted through it along path f to impinge upon half wave plate 16, while s-polarized components incident upon it along path h are reflected by it along path f to impinge upon half wave plate 16.

Mirror 19 is optically connected to polarizer 17 by optical path h and to a mirror 20 by optical path i. Mirror 19 reflects photons incident upon it along optical path h to optical path i and vice versa. Thus, photons incident upon it in the forward direction along path h are reflected along path i to mirror 20, while photons incident upon it in the reverse direction along path i are reflected along path h to polarizer 17.

Mirror 20 is optically connected to mirror 19 by optical path i and to polarizer 18 by optical path j. Mirror 20 reflects photons incident upon it from optical path i to optical path j to polarizer 18, while photons incident upon it in the reverse direction are reflected along optical path i to mirror 19. Optical paths h, i and j are designed such that s-polarized components are delayed relative to their corresponding p-polarized components by a time interval chosen to be small enough that there is little likelihood that the index of refraction in a target region (not shown) will be changed during the interval. By way of example only, this time interval may be on the order of 20 ns in the described embodiment.

Polarizer 18 is optically connected to polarizer 17 by optical path g, to mirror 20 by optical pathj and to an aperture 21 by optical path k. Polarizer 18 transmits p-polarized components of photons in both the forward and reverse directions, and reflects s-polarized components. Thus, in the forward direction, p-polarized components incident upon it along path g are transmitted through it along path k to impinge upon aperture 21, while s-polarized components incident upon polarizer 18 along path j are reflected by it along path k to impinge upon aperture 21. In the reverse direction, p-polarized components incident upon it along path k are transmitted through it along path g to impinge upon polarizer 17, while s-polarized components incident upon it along path k are reflected by it along path j to impinge upon mirror 20.

Aperture 21 is optically connected to polarizer 18 by optical path k and to a Faraday rotator 22 by optical path 1. Aperture 21 selects the so-called TEMₒₒ mode (transverse excited mode) in the beam of photons passing therethrough in order to ensure the lowest possible divergence of the photon beam.

Faraday rotator 22 is optically connected to aperture 21 by optical path l and to dichroic mirror 23 by optical path m. The Faraday rotator 22 is an irreversible optical element that rotates the linear polarization of the photons incident upon it by +45°. Thus, photons travelling in the forward direction along path l from aperture 21 to Faraday rotator 22, exit from it along path m with their linear polarization rotated by +45°, to impinge upon dichroic mirror 23. Photons travelling in the reverse direction along path m from dichroic mirror 23 to Faraday rotator 22, exit from it along path l with their linear polarization increased by +45° to impinge upon aperture 21.

Dichroic mirror 23 is optically connected to Faraday rotator 22 by optical path m and a concave lens 24 by optical path n. It transmits photons incident upon it along path m to path n and vice versa. The dichroic mirror 23 also accepts incident photons 50 along optical path u and reflects them along path n, along the same path as photons incident upon dichroic mirror 23 along path m. Thus, photons 50 incident upon dichroic mirror 23 along path u as well as photons incident upon it along path m exit from it along path n to impinge upon lens 24, while photons incident upon dichroic mirror 23 along path n are transmitted therethrough and exit from it along path m to impinge upon Faraday rotator 22.

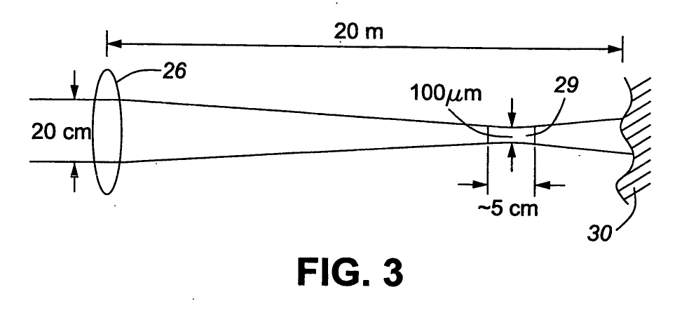

Concave lens 24 is optically connected to dichroic mirror 23 by optical path n and to a convex lens 25 by optical path o. Convex lens 25 is optically connected to concave lens 24 by optical path o and to an objective lens 26 by optical path p. Concave lens 24 has a common optical axis with convex lens 25 and works in conjunction therewith to form a telescope to expand the beam diameter in the forward direction, for example, to 20 cm as shown in FIG. 3, to have a narrower beam waist in the focal region 29, typically in the range of hundreds of microns, as shown in FIG. 3, to provide high spatial resolution. Those having ordinary skill in the art will readily recognize that the introduction of such a telescope contributes no new aspects to the inventive principle described herein, but rather assists in obtaining satisfactory results in the practical implementation of the inventive principle. In any event, in the forward direction, photons incident upon the telescope along path n exit from it along path o to impinge on objective lens 26.

Objective lens 26 is optically connected to convex lens 25 along optical path p and to a focal region 29 along optical path q. Objective lens 26 focuses the beam into focal region 29. Preferably, the focal distance from the objective to the focal region 29 is long, typically in the range of tens of metres, as shown in FIG. 3. It is presumed that focal region 29 is positioned proximate to some surface 30 that will permit some back-scattering of the beam, which may be solid or liquid, also as shown in FIG. 3.

Having now explained the components of the apparatus 10, the manner in which an unknown substance located in a target region (not shown), proximate to the focal region 29, may be analysed thereby to detect trace amounts of a substance or substances under investigation can now be understood.

The apparatus 10 accepts as input, a sequence of both probing pulses 40 and excitation pulses 50. The apparatus 10 delivers both pulses 40, 50 to the focal region 29 and returns the pulses 40 back to at least polarizer 14. Focal region 29 is thought to contain a gaseous admixture including trace or higher concentrations of a substance to be detected (not shown) situated proximate to a target region (not shown) corresponding to vapours of a target medium under investigation.

For reasons that will be described later, probing pulses 40 comprise two separate and alternating pulse trains, each of which is identical and initially linearly polarized. Pulses of the first pulse train will be denoted reference pulses R and pulses corresponding to the second pulse train will be denoted probing pulses P.

For ease of reference in the following discussion, the linearly polarized components of reference pulse R will be denoted R₁ and R₂ respectively. Likewise, the linearly polarized components of probing pulse P will be denoted P₁ and P₂ respectively. To identify their polarization from time to time, the suffix (s) or (p) will be applied to such components as appropriate. As well, pulses and/or components traveling in the reverse direction will be so indicated by the adoption of a^{b} superscript.

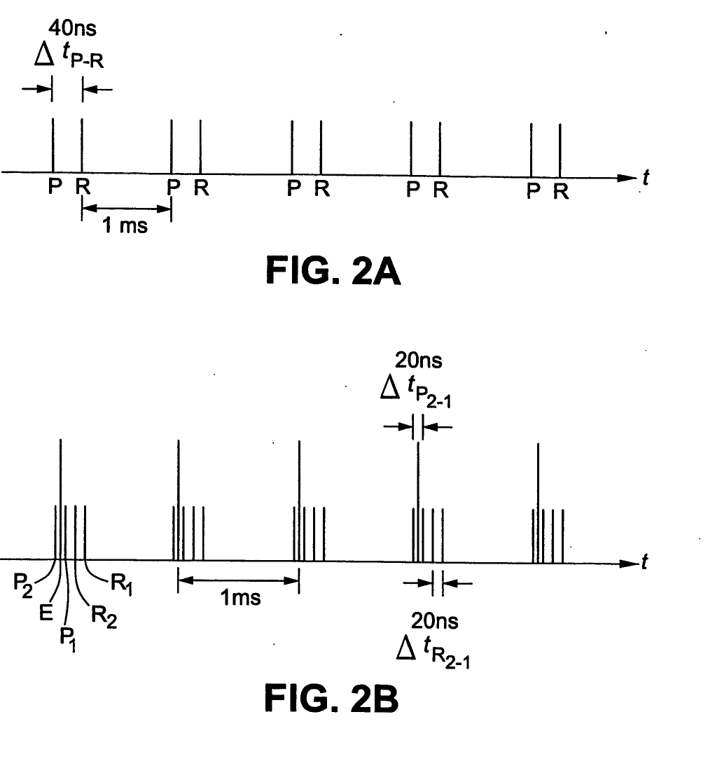

Probing pulses P follow their corresponding reference pulses R in time by a delay Δt_{P-R}, which may be of a duration of at least twice that of the delay provided by the passage of p-polarized components along paths h-i-j relative to the passage of the corresponding s-polarized component along path g, an exemplary value of which, in the described embodiment, is 20 ns. Thus, a suitable value for Δt_{P-R} may be 40 ns, as shown in FIG. 2A. Probing pulse P and the next reference pulse R are separated by a duration sufficient to permit processing of the p- and s-polarization components monitored at photodiodes 27, 28 of the previous pulse pair, which may, by way of example only, be 1 ms in the described embodiment, also as shown in FIG. 2A.

The optical beam path followed by each reference pulse R in the probing beam 40 will now be described. The R pulse encounters the optical apparatus 10 at polarizer 11. The p-polarized component of the R pulse, R(p), passes entirely through polarizer 11, while any s-polarized component is reflected off. Faraday rotator 12 and half wave plate 13 act so as to change the linear polarization of photons incident upon Faraday rotator 12 along path a in the forward direction by +90° so that R(s) is s-polarized when it encounters polarizer 14 along path c. Because R(s) is s-polarized, polarizer 14 reflects it along optical path d, whereupon it encounters mirror 15 and is reflected along path e through half wave plate 16 along path f Half wave plate 16 is oriented such that the linear polarization of pulses emerging from it along path f is oriented at +45°. Thus, upon exit from half wave plate 16, reference pulse R has both s-polarized and p-polarized components of equal amplitude, denoted R₁(p) and R₂(s) respectively. R₁(p) is transmitted by polarizer 17 along path g to polarizer 18. On the other hand, R₂(s) is reflected by polarizer 17 along path h and is reflected by mirrors 19 and 20 to polarizer 18 along paths i and j respectively. Mirrors 19 and 20 serve to delay in time the arrival at polarizer 18 of the s-polarized pulses R₂(s) relative to their p-polarized counterparts R₁(p), by a time interval Δt_{R2-1}, which in the described embodiment, may be 20 ns, as shown in FIG. 2B.

Component R₁(p) is transmitted by polarizer 18 along path k through aperture 21 to Faraday rotator 22. After a time interval Δt_{R2-1}, component R₂(s) is reflected by polarizer 18 along path k through aperture 21 to Faraday rotator 22. Faraday rotator 22 rotates the linear polarization of both components by +45°. R₁ and R₂ thereafter pass through dichroic mirror 23 and telescope lenses 24 and 25 along paths l through p respectively, whereupon they are focused into the focal region 29 by objective lens 26 along path q.

The pulse components R₁ and R₂ are back-scattered by surface 30 proximate to focal region 29. A small fraction of these back-scattered pulse components, denoted R₁^{b} and R₂^{b} respectively, is captured by objective lens 26 and sent in the reverse direction back through the telescope lenses 25 and 24 and dichroic mirror 23 to Faraday rotator 22 along paths q through m respectively, further rotating their linear polarization by +45°, or a total of 90° by the double passage through the Faraday rotator 22. As a result, pulse component R₁^{b}(p) exits Faraday rotator 22 along path 1 as R₁^{b}(s). Accordingly, after passing through aperture 21 along path k, pulse component R₁^{b}(s) is reflected by polarizer 18 along path j and thereafter by mirrors 20 and 19 along paths i and h to polarizer 17. At this point, R₁^{b}(s) has phase Φ_{R1}.

In the same way, the pulse component R₂^{b}(s) exits Faraday rotator 22 along path l as R₂^{b}(p) and is transmitted through polarizer 18 along path g to polarizer 17, having at that point, phase Φ_{R2}. Because Δt·_{R2-1} is sufficiently small, the index of refraction will not be changed during this interval so that Φ_{R2}=Φ_{R1}.

Upon passing through polarizer 17 along path f, the delay introduced into R₂(s) in the forward direction is compensated by introducing a corresponding delay into R₁^{b}(s) in the reverse direction, so that the two components are again simultaneous and thus coherently coupled back into a single reference pulse Rb, which is able to return along path f through the half wave plate 16. This restores the polarization state of R^{b} along path e to that of R along path e in the forward direction. Accordingly, the return reference pulse R^{b} exits half wave plate 16 along path e with s-polarization only and is reflected by mirror 15 along path d to encounter polarizer 14. R^{b} is only s-polarized, so it is reflected by polarizer 14 along path c to half wave plate 13. As earlier indicated, in the reverse direction, the passage of a pulse through half wave plate 13 and Faraday rotator 12 does not affect the pulse's polarization because half wave plate 13 rotates the linear polarization by −45°, while Faraday rotator 12 rotates the linear polarization by +45°. Thus, when R^{b} emerges along path a from Faraday rotator 12, it continues to have s-polarization. Accordingly, it is reflected by polarizer 11 along path s to photodiode 28, which will detect its incidence.

In the absence of an excitation pulse 50 or if there is no resonant absorption of an excitation pulse 50 in the focal region 29 as discussed below, the apparatus 10 affects the probing pulse P of the input beam 40 in similar fashion. Thus, the pulse component P₂(s) will arrive at polarizer 18 a time interval Δt_{P2-1}, as shown in FIG. 2B, after the pulse component P₁(p) once it passes along paths h, i and j past mirrors 19 and 20. As well, pulse component P₁^{b}(s) will arrive at polarizer 17 with phase Φ_{P1}, while pulse component P₂^{b}(P) will arrive at polarizer 17 with phase Φ_{P2}.

The only difference between probing pulse P and reference pulse R is in the interposition, between the polarized probing pulse components P₁(p) and P₂(s), of an excitation or pumping pulse 50. The excitation pulses E are powerful laser pulses at a tuned wavelength that corresponds to an absorption line of the substance(s) to be detected in the target region. Each excitation pulse E is directed at dichroic mirror 23 and reflected along path n, through telescope lenses 24, 25 along paths o and p respectively whereupon it is focused into focal region 29 by objective lens 26 along path q. As can be seen from FIG. 2B, which shows the timing of the train of pulses as it passes along beam path n (on the way to the target region), the excitation pulse E is timed to pass between probing pulses P₁ and P₂.

Thus, if focal region 29 contains a resonantly absorbing substance, the refractive index of the focal region 29 will be changed due to heat deposited into it by the excitation pulse E. This change in the refractive index causes a change in the phase of the wave back-scattered by surface 30 and transmitted through the heated focal region 29 in the reverse direction. We note that while resonant absorption can induce change in the refractive index through a number of nonlinear optical mechanisms, the present invention exploits the thermooptical effect only.

If there was no trace of the substance(s) to be detected in the focal region 29, there would be no change in the refractive index of the focal region 29 as a result of the excitation pulse E, and Φ_{P2}=Φ_{P1} because, as shown in FIG. 2B, Δt_{P2-1} is the same as Δt_{R2-1} and sufficiently small that the index of refraction will not be changed. Thus, the linear polarization of the back-scattered probing pulse P^{b} would be identical to that of the input linear polarized probing pulse P.

However, if the gas admixture in the focal region 29 resonantly absorbs the excitation pulse E, signifying the presence of the substance(s) to be detected in the target, the phase Φ_{P2} for the back scattered probing pulse P₂^{b} traveling through the focal waist would be different from that of the back scattered probing pulse P₁^{b}, namely Φ_{P1}. In such a situation, the optical paths for probing pulses P₁^{b} and P₂^{b} differ by 1·Δn, so that the phase shift between these two pulses at the exit of polarizer 17 in the reverse direction is defined by the relation:
ΔΦ=Φ_{P2}−Φ_{P1}=(2·π/λ)(Δn·1) (1)
where λ is the wavelength of the photons focused into the target region, l is the length of the beam waist and Δn is the change of the refractive index due to heating of the medium in the focal waist.

If ΔΦ=0, signifying that there was no change in the refractive index as a result of the excitation pulse E, and further suggesting the absence of the substance(s) to be detected in the target medium, pulses P₁^{b} and P₂^{b}, after being coherently combined by polarizer 17 as described above, would result in an s-polarized output probing pulse P^{b} along path e, after passing through half wave plate 16. Thus, it would be eventually detected by photodiode 28 but not at photodiode 27.

On the other hand, if ΔΦ≠0, signifying that there was a change in the refractive index as a result of the excitation pulse E, and further suggesting the presence of the substance(s) to be detected in the target region, a p-polarization component would appear in the polarization of P^{b}. Depending upon the absolute value of ΔΦ, a certain portion P_{prob}, of output probing pulse P^{b} will be transmitted by polarizer 14 to photodiode 27.

Those having ordinary skill in this art will readily recognize that there will always be some depolarization of pulses while passing through optical components. Therefore, it is likely that there will be a p-polarization component P_{ref} of output reference pulse R^{b} that will be transmitted by polarizer 14 to photodiode 27 and thus give rise to a false positive reading. However, such depolarization should be the same for pulses traversing the same optical paths.

Moreover, such false readings may be minimized by comparing the ratio between the s-polarization component S_{ref} and p-polarization component P_{ref} of the returned reference signal R^{b}, which is known not to have had the imposition of any excitation pulse E, with the ratio between the s-polarization component the probing pulse S_{prob} and p-polarization component P_{prob} of the returned probing signal P^{b}, which has.

This comparison also obviates the necessity to measure the actual phase of the returned probing signal P^{b}, which may not be trivial. Rather, the apparatus 10 is required only to process the amplitude of the linearly orthogonal polarization components of the returned probing signal P^{b} (and those of the returned reference signal R^{b} if optical depolarization is to be ruled out). The amplitude response is easily obtained and can be suitably amplified or attenuated by proper circuit design, such as would be known to a person of ordinary skill in this art.

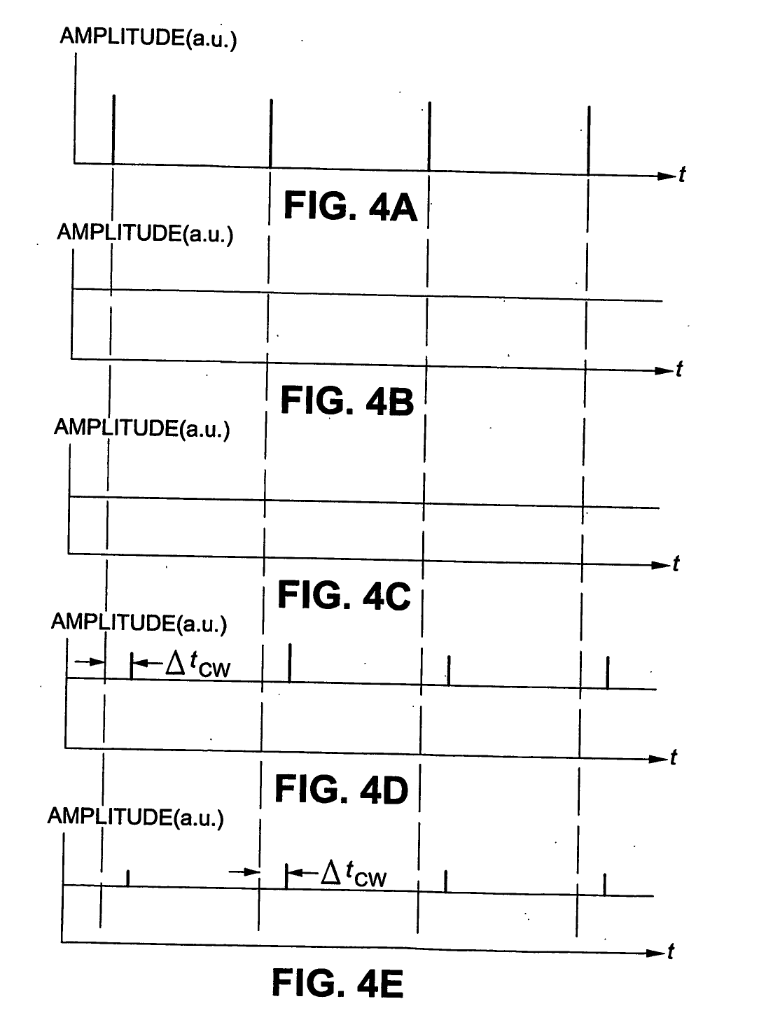

Those having ordinary skill in this art will readily recognize that the inventive features of such an apparatus are not technically restricted to operation with pulsed lasers. Indeed, the optical diagram of FIG. 1 would be equally applicable in an embodiment in which laser emission 40 was not a train of pulses but a continuous wave (CW) laser photon stream. FIG. 4A shows the amplitude response as a function of time for the introduction of the excitation pulse E. Assuming that the laser emission 40 is a CW photon stream, one would expect a relatively constant amplitude response at both photodiodes 27 and 28, irrespective of the interposition of any excitation pulses E, as shown in FIGS. 4B and 4C respectively, in the absence of the substance(s) under investigation in the target region.

Where, however, a substance under investigation is present in the focal region 29, which resonantly absorbs the excitation pulses E, one would expect a series of transient perturbations in the amplitude response over time of one or both of photodiodes 27 and 28, as shown in FIGS. 4D and 4E respectively. Such transients will temporally correspond to the timing of the excitation pulses E and be delayed by a delay Δt_{CW}. The magnitude and sign of such transient would be dependent upon the actual configuration of the electronics to detect, amplify and display the photodiodes' electrical amplitude response, but the mere presence of such transients would provide a qualitative indication of the presence of the substance under investigation.

Those having ordinary skill in the relevant art will also recognize that there may exist a mathematical or empirical relation that may allow these perturbations to be measured in order to generate a quantitative approximation of the quantity of the substance under investigation, but the development and explanation of such relations is beyond the scope of the present invention.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the appended claims.

We claim:

1. An apparatus for non-contact detection of a substance in a target region, comprising:
a laser source for generation of a probing light emission;
an optical subsystem adapted to split a light emission into first and second emission components and to introduce a first delay to the second emission component relative to the corresponding first emission component;
a lens subsystem adapted to accept all of the components in sequence and direct them to a focal region proximate to the target region along an optical axis;
an excitation source adapted to direct energy at a wavelength corresponding to an absorption line in the spectrum of the substance, through the lens subsystem to the focal region, at a time between the first and second components so as to change the refractive index in the focal region if the substance is present in the target region before the passage of the second component through the focal region;
an emission coupler adapted to:
recover back-scattered returns of the emission components,
introduce a second delay to the first returned emission component relative to the second returned emission component in an amount equal to the first delay, and
coherently couple the emission components into a returned light emission; and
a detection subsystem adapted to measure components of the returned emission to determine if there has been a change in the phase of the second returned emission component as a result of the presence of the substance in the target region.

2. An apparatus as claimed in claim 1, wherein the first and second emission components have linear polarizations orthogonal to each other.

3. An apparatus as claimed in claim 2, wherein the first emission component is p-polarized.

4. An apparatus as claimed in claim 2, wherein the optical subsystem comprises a plurality of polarizers adapted to transmit the first emission component directly therebetween but to reflect the second emission component along a diverted optical path therebetween having an additional length that corresponds to the amount of the first delay.

5. An apparatus as claimed in claim 4, wherein the emission coupler is adapted to alter the polarization of the first and second recovered emission components so that they correspond to the polarization of the second and first emission components respectively and thereafter to return them through the optical subsystem to provide the second delay and to coherently couple the resulting emission components.

6. An apparatus as claimed in claim 5, wherein the emission coupler comprises a Faraday rotator adapted to rotate the linear polarization of the emission components by +45° before passing through the lens subsystem and to rotate the linear polarization of the recovered emission components by an additional +45°.

7. An apparatus as claimed in claim 2, wherein the detection subsystem comprises a detector of linearly polarized emission components of the returned emission.

8. An apparatus as claimed in claim 7, wherein the detector comprises a photodiode.

9. An apparatus as claimed in claim 1, wherein the lens subsystem comprises a dichroic mirror adapted to transmit the first and second emission components therethrough and to reflect the energy at a time between the first and second emission components along the optical axis.

10. An apparatus as claimed in claim 1, wherein the lens subsystem comprises a telescope lens assembly to increase the beam diameter.

11. An apparatus as claimed in claim 1, wherein the lens subsystem comprises an objective lens to focus the beam in the focal region.

12. An apparatus as claimed in claim 1, wherein the excitation source is a laser.

13. An apparatus as claimed in claim 12, wherein the excitation source is tunable to a wavelength corresponding to an absorption spectrum line of the substance.

14. An apparatus as claimed in claim 1, wherein the probing emission is emitted in the form of a probing pulse.

15. An apparatus as claimed in claim 14, wherein the laser source emits a reference pulse before the probing pulse.

16. An apparatus as claimed in claim 15, wherein the detection subsystem determines the presence of the substance in the target region by comparing the ratio of the amplitudes of orthogonally polarized components of a returned emission corresponding to the reference pulse with the ratio of the amplitudes of orthogonally polarized components of a returned emission corresponding to the probing pulse to detect a change in the phase of the second returned emission component corresponding to the probing pulse.

17. An apparatus as claimed in claim 1, wherein the laser emits the light emission as a continuous wave.

18. An apparatus as claimed in claim 17, wherein the detection subsystem is adapted to detect transients in the returned emission.

19. An apparatus as claimed in claim 18, wherein the detection subsystem detects the presence of the substance in the target region by detecting transients in the returned emission that are temporally related to the generation of energy by the excitation source.

20. A method for non-contact detection of a substance at a target region, comprising the steps of:
radiating a probing light emission;
splitting the emission into a first and second emission component;
delaying in time the second emission components relative to the first emission component;
directing all of the emission components in sequence to a focal region proximate to the target region;
directing energy at a wavelength corresponding to an absorption line in the spectrum of the substance to the focal region a a time between the first and second emission components so as to change the refractive index in the focal region if the substance is present in the target region;
recovering back-scattered returns of the emission components;
delaying in time first returned emission component relative to the second returned emission component by an amount equal to the initial delay;
coherent coupling the emission components into a returned emission,
measuring components of the returned emission to determine if there has been a change in the phase of the second returned emission component as a result of the presence of the substance in the target region.
